(19) United States
(12) Patent Application Publication
(10) Pub. No.: US 2016/0218795 A1
(43) Pub. Date: Jul. 28, 2016

(54) METHOD AND APPARATUS FOR ALLOCATING TRANSMISSION TIME FOR BI-DIRECTIONAL RELAY

(71) Applicant: Electronics and Telecommunications Research Institute, Daejeon (KR)

(72) Inventor: Dae Soon Cho, Daejeon (KR)

(21) Appl. No.: 15/005,456

(22) Filed: Jan. 25, 2016

(30) Foreign Application Priority Data
Jan. 26, 2015 (KR) 10-2015-0012388
Jan. 25, 2016 (KR) 10-2016-0008806

(51) Int. Cl. H04B 7/155; H04W 72/04

(52) U.S. Cl. CPC H04B 7/15542; H04W 72/0446

(57) ABSTRACT

A method and an apparatus for allocating a transmission time for a bi-directional relay are proposed. In a bi-directional relay system in which bi-directional communication is performed between a first node and a second node, basic parameters for transmission time allocation are acquired, where the basic parameters include a first transmission power of a signal transmitted from the first node and a second transmission power of a signal transmitted from the second node. A plurality of intersecting times at which sums of transmission rates for nodes become equal are calculated by using the basic parameters, and a transmission time is allocated based on the plurality of the intersecting times, the first transmission power, and the second transmission power.

### CROSS-REFERENCE TO RELATED APPLICATION

This application claims priority to and the benefit of Korean Patent Application Nos. 10-2015-0012388 and 10-2016-0008806 filed in the Korean Intellectual Property Office on Jan. 26, 2015 and Jan. 25, 2016, the entire contents of which are incorporated herein by reference.

### BACKGROUND OF THE INVENTION

(a) Field of the Invention

The present invention relates to a method and an apparatus for allocating transmission time for a bi-directional relay.

(b) Description of the Related Art

Recently, wireless communication traffic has been rapidly increasing, which makes effective utilization of wireless communication resources, such as frequency, time, and the like, more important. In view of the above, research on a bi-directional relay technology having about double spectrum efficiency compared to a uni-directional relay system having low spectrum efficiency has been conducted.

In a bi-directional relay system, a base station and a terminal generally performs bi-directional communication, and bi-directional communication represents that the base station transmits downlink data to the terminal through a relay and the terminal transmits uplink data to the base station through a relay.

In the bi-directional communication, at least four slots are needed. Specifically, when the base station transmits downlink data to the terminal, two time slots, that is, a time slot in which data from the base station is transmitted to a relay through downlink (base station→relay) and a time slot in which the data received by the relay is demodulated, decoded, encoded, modulated, and then transmitted to the terminal through downlink (relay→terminal) are needed. In addition, when the terminal transmits uplink data to the base station, two time slots, that is, a time slot in which data from the terminal is transmitted to a relay through uplink (terminal→relay) and a time slot in which the data received by the relay is demodulated, decoded, encoded, modulated, and then transmitted to the base station through uplink (relay→base station) are needed. Therefore, for the bi-directional communication between the base station and the terminal, a total of four slots are used.

In order to reduce the number of time slots used in bi-directional communication, a bi-directional relay system using network encoding has been proposed.

In the bi-directional relay system using network encoding, three slots are needed for the bi-directional communication between the base station and the terminal. Specifically, the three time slots include a time slot in which data from the base station is transmitted to a relay through downlink (base station→relay), a time slot in which data from the terminal is transmitted to the relay through uplink (terminal→relay), and a time slot in which the data from the base station and the terminal is demodulated and decoded to obtain data bits, network encoding on the data bits is performed, the network encoded bits are encoded and modulated to obtain symbols, and then the symbols are broadcasted to the base station and the terminal by the relay.

As above, the relay combines signals received bi-directionally by using the network encoding and transmits the combined signals at the same time, and thereby it is possible to reduce data transmission time. Accordingly, the throughput and spectral efficiency may be enhanced.

However, because the theoretical optimal solution on transmission time allocation to achieve the maximum transmission capacity has not been known in the bi-directional relay system using the network encoding, the transmission capacity could not be maximized. Accordingly, the transmission efficiency is low.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a method and an apparatus having advantages of allocating a transmission time for maximum transmission capacity in a bi-directional relay system using physical layer network coding (PNC).

An exemplary embodiment of the present invention provides a method for allocating a transmission time in a bi-directional relay system in which bi-directional communication is performed between a first node and a second node through a relay. The method includes acquiring basic parameters for transmission time allocation, where the basic parameters include a first transmission power of a signal transmitted from the first node and a second transmission power of a signal transmitted from the second node; calculating a plurality of intersecting times at which sums of transmission rates for nodes become equal by using the basic parameters; and allocating a transmission time based on the plurality of the intersecting times, the first transmission power, and the second transmission power.

The allocating of a transmission time may include determining a transmission time and then allocating a first final transmission time and a second final transmission time based on the determined transmission time, wherein the first final transmission may correspond to a first time duration in which a signal from the first node is transmitted to the relay and a signal from the second node to the relay and the second final transmission time may correspond to a second time duration in which the relay processes received signals and transmits them to the first node and the second node.

The plurality of intersecting times may include a first intersecting time, a second intersecting time, and a third intersecting time based on a time at which a sum of transmission rates between the first node and the relay and a sum of transmission rates between the second node and the relay become equal.

The allocating of transmission times may include comparing the first intersecting time with the second intersecting time; comparing the first transmission power with the third transmission power or the second transmission power with the third transmission power based on the results of the comparison of intersecting times; and allocating transmission time by using the results of the comparison of intersecting times or the results of the comparison of transmission powers.

The comparing the first transmission power may include comparing the first transmission power and the third transmission power when the first intersecting time is greater than the second intersecting time.

The allocating of a transmission time may include determining the first intersecting time as a transmission time when the first transmission power is greater than the third transmission power.

The allocating of a transmission time may include determining a time between the second intersecting time and the first intersecting time as a transmission time when the first transmission power is the same as the third transmission power.

The allocating of a transmission time may include determining the second intersecting time as a transmission time when the third transmission power is greater than the first transmission power.

The allocating of a transmission time may include determining the first intersecting time or the second intersecting time as a transmission time when the first intersecting time is the same as the second intersecting time.

The comparing the first transmission power may include comparing the second transmission power with the third transmission power when the first intersecting time is greater than the second intersecting time.

The allocating of a transmission time may include allocating the second intersecting time as a transmission time when the second transmission power is greater than the third transmission power.

The allocating of a transmission time may include allocating a time between the first intersecting time and the second intersecting time as a transmission time when the second transmission power is the same as the third transmission power.

The allocating of a transmission time may include allocating the first intersecting time as a transmission time when the third transmission power is greater than the second transmission power.

The determining of a transmission time may allocate the determined transmission time as the first final transmission time, and allocate the second final transmission time based on the first final transmission time, where a condition of the second final transmission time=1—the first final transmission time is satisfied.

The basic parameters may include a first channel coefficient for a channel between the first source node and the relay and a second channel coefficient for a channel between the second source node and the relay, and the sum of transmission rates may include a first sum of transmission rates, a second sum of transmission rates, a third sum of transmission rates, and a fourth sum of transmission rates, wherein the first intersecting time may represent a time when a point at which the second sum of transmission rates and the fourth sum of transmission rates intersect and a point at which the third sum of transmission rates and the first sum of transmission rates intersect are the same, and the second intersecting time may represent a time when a point at which the second sum of transmission rates and the first sum of transmission rates intersect and a point at which the third sum of transmission rates and the fourth sum of transmission rates intersect are the same, wherein the first sum of transmission rates may represent a sum of a transmission rate from the first node to the relay and a transmission rate from the second node to the relay, the second sum of transmission rates may represent a sum of a transmission rate from the first node to the relay and a transmission rate from the relay to the first node, the third sum of transmission rates represents a sum of a transmission rate from the second node to the relay and a transmission rate from the relay to the second node, and the fourth sum of transmission rates may represent a sum of a transmission rate from the relay to the second node and a transmission rate from the relay to the first node.

Another embodiment of the present invention provides an apparatus for allocating a transmission time in a bi-directional relay system in which bi-directional communication is performed between a first node and a second node through a relay. The apparatus includes a wireless frequency converter configured to transmit/receive a signal through an antenna; and a processor connected to the wireless frequency converter and configured to process transmission time allocation, wherein the processor comprises: a parameter acquiring processor configured to acquire basic parameters for transmission time allocation, where the basic parameters include a first transmission power of a signal transmitted from the first node, a second transmission power of a signal transmitted from the second node, a first channel coefficient for a channel between the first source node and the relay, and a second channel coefficient for a channel between the second source node and the relay; an intersecting time calculator configured to calculate a plurality of intersecting times at which sums of transmission rates for nodes become equal by using the basic parameter; a first comparison processor configured to compare a first intersecting time with a second intersecting time; a second comparison processor configured to compare the first transmission power and the third transmission power or to compare the second transmission power and the third transmission power based on the results of the comparison by the first comparison processor; and a transmission time allocation processor configured to allocate a transmission time based on the results of the comparison by the first comparison processor or the results of the comparison by the second comparison processor.

The transmission time allocation processor may be configured to determine a transmission time and then allocate a first final transmission time and a second final transmission time based on the determined transmission time, wherein the first final transmission may correspond to a first time duration in which a signal from the first node is transmitted to the relay and a signal from the second node is transmitted to the relay, the second final transmission time may correspond to a second time duration in which the relay processes received signals and transmits them to the first node and the second node, and a condition of the second final transmission time=1—the first final transmission time is satisfied.

The first sum of transmission rates may represent a sum of a transmission rate from the first node to the relay and a transmission rate from the second node to the relay, the second sum of transmission rates may represent a sum of a transmission rate from the first node to the relay and a transmission rate from the relay to the first node, the third sum of transmission rates may represent a sum of a transmission rate from the second node to the relay and a transmission rate from the relay to the second node, and the fourth sum of transmission rates may represent a sum of a transmission rate from the relay to the second node and a transmission rate from the relay to the first node.

The transmission time allocation processor may be configured to determine the first intersecting time as a transmission time when the first intersecting time is greater than the second intersecting time and the first transmission power is greater than the third transmission power, the transmission time allocation processor may be configured to determine a time between the second intersecting time and the first intersecting time as a transmission time when the first intersecting time is greater than the second intersecting time and the first transmission power is the same as the third transmission power, and the transmission time allocation processor may be configured to determine the second intersecting time as a transmission time when the first intersecting time is greater than the second intersecting time and the third transmission power is greater than the first transmission power.

The transmission time allocation processor may be configured to determine the first intersecting time or the second intersecting time as a transmission time when the first intersecting time is the same as the second intersecting time, the transmission time allocation processor may be configured to determine the second intersecting time as a transmission time when the first intersecting time is greater than the second intersecting time and the second transmission power is greater than the third transmission power, the transmission time allocation processor may be configured to determine a time between the second intersecting time and the first intersecting time as a transmission time when the first intersecting time is greater than the second intersecting time and the second transmission power is the same as the third transmission power, and the transmission time allocation processor may be configured to determine the first intersecting time as a transmission time when the first intersecting time is greater than the second intersecting time and the third transmission power is greater than the second transmission power.

### BRIEF DESCRIPTION OF THE DRAWINGS

FIG. 1 shows a diagram illustrating a bi-directional relay system.

FIG. 2 shows a flowchart of a method for allocating transmission time according to an exemplary embodiment of the present invention.

FIG. 3 shows a diagram illustrating a structure of an apparatus for allocating transmission time according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the specification, in addition, unless explicitly described to the contrary, the word “comprise” and variations such as “comprises” or “comprising” will be understood to imply the inclusion of stated elements but not the exclusion of any other elements.

Hereinafter, a method and an apparatus for allocating transmission time according to an exemplary embodiment of the present invention will be described.

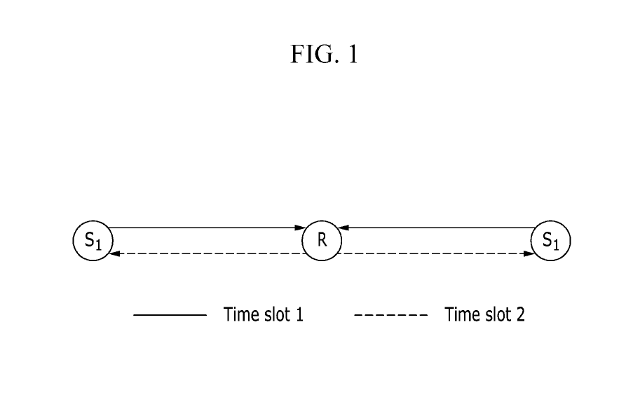

FIG. 1 shows a diagram illustrating a bi-directional relay system.

As shown in FIG. 1, a bi-directional relay system includes a plurality of nodes, specifically, two source nodes S1 and S2, and a relay R.

During the first time duration, the source nodes S1 and S2 simultaneously transmit a signal to the relay R. At this time, a signal x₁ is transmitted from the source node S1 with transmission power P₁, and a signal x₂ is transmitted from the source node S2 with transmission power P₂.

The relay R receives the signals x₁ and x₂ transmitted from the source node S1 and the source node S2, and the signal y_{R} received by the relay R may be represented as follows.

y_{R}=h₁x₁+h₂x₂+n_{R} [Equation 1]

Here, n_{R} represents additive white Gaussian noise (AWGN) in a channel in which the mean is 0 and the variance is 1. h₁ represents a channel coefficient for a channel from the source node S1 to the relay R, and h₂ represents a channel coefficient for a channel from the source node S2 to the relay R.

Also, during the second time duration, the relay R performs physical-layer network coding (PNC) mapping on the received signal y_{R} to obtain a PNC modulation signal x_{R}. The relay R simultaneously transmits the PNC modulation signal x_{R} to the source nodes S1 and S2.

The signals received by the source nodes S1 and S2 may be represented as follows.

y₁=h₁x_{R}+n₁

y₂=h₂x_{R}+n₂ [Equation 2]

Here, y₁ represents the signal that is transmitted from the relay R and then received by the source node S1, y₂ represents the signal that is transmitted from the relay R and then received by the source node S2, and n₁ and n₂ represents the AWGN.

In this bi-directional communication, the sum transmission rate Rₛᵤₘ is as follows.

Rₛᵤₘ(Δ₁,Δ₂)=min(R_{1R},R_{R2})+min(R_{2R},R_{R1}) [Equation 3]

Here, R_{1R} represents the transmission rate of the signal transmitted from the source node S1 to the relay R, and R_{R2} represents the transmission rate of the signal transmitted from the relay R to the source node S2. In addition, R_{R1} represents the transmission rate of the signal transmitted from the relay R to the source node S1, and R_{2R} represents the transmission rate of the signal transmitted from the source node S2 to the relay R.

In addition, Δ₁ represents transmission time corresponding to the first time duration, and Δ₂ represents transmission time corresponding to the second time duration.

Here, each of the transmission rates satisfies the following conditions.

R_{1R}=Δ₁ log₂(1+|h₁|²P₁)

R_{R2}=Δ₂ log₂(1+|h₂|²P_{R})

R_{2R}=Δ₁ log₂(1+|h₂|²P₂)

R_{R1}=Δ₂ log₂(1+|h₁|²P_{R}) [Equation 4]

Here, P₁ represents the transmission power of the source node S1, P₂ represents the transmission power of the source node S2, and P_{R} represents the transmission power of the relay R.

If Equation 4 is applied to Equation 3, the sum transmission rate may be represented as follows.

min{Δ₁ log₂(1+|h₁|²P₁), Δ₂ log₂(1+|h₂|²P_{R})}+min{Δ₁ log₂(1+|h₂|²P₂), Δ₂ log₂(1+|h₁|²P_{R})} [Equation 5]

Also, this sum transmission rate may be briefly represented as follows.

Rₛᵤₘ(Δ₁,Δ₂)=min{gᵢ(Δ₁,Δ₂)} for i=0, . . . , 3 [Equation 6]

In this case, the function of each g may be defined as follows.

g₀(Δ₁,Δ₂)=R_{1R}+R_{2R}=Δ₁ log₂(1+|h₁|²P₁)+Δ₁ log₂(1+|h₂|²P₂),

g₁(Δ₁,Δ₂)=R_{1R}+R_{R1}=Δ₁ log₂(1+|h₁|²P₁)+Δ₂ log₂(1+|h₁|²P_{R}),

g₂(Δ₁,Δ₂)=R_{R2}+R_{2R}=Δ₂ log₂(1+|h₂|²P_{R})+Δ₁ log₂(1+|h₂|²P₂),

g₃(Δ₁,Δ₂)=R_{R2}+R_{R1}=Δ₂ log₂(1+|h₂|²P_{R})+Δ₂ log₂(1+|h₁|²P_{R}). [Equation 7]

Further, by using Δ₂=1−Δ₁, the sum transmission rate during the first time duration may be represented as follows.

Rₛᵤₘ(Δ₁)=min{fᵢ(Δ₁)} for i=0, . . . , 3 [Equation 8]

At this time, the function of each f may be represented as follows.

$${f}_{0} ( {Δ}_{1} ) = {Δ}_{1} \{ {log}_{2} ( 1 + {\vert {h}_{1} \vert}^{2} {P}_{1} ) + {log}_{2} ( 1 + {\vert {h}_{2} \vert}^{2} {P}_{2} ) \} , \\ {f}_{1} ( {Δ}_{1} ) = {Δ}_{1} {log}_{2} \frac{1 + {\vert {h}_{1} \vert}^{2} {P}_{1}}{1 + {\vert {h}_{1} \vert}^{2} {P}_{R}} + {log}_{2} ( 1 + {\vert {h}_{1} \vert}^{2} {P}_{R} ) , \\ {f}_{2} ( {Δ}_{1} ) = {Δ}_{1} {log}_{2} \frac{1 + {\vert {h}_{2} \vert}^{2} {P}_{2}}{1 + {\vert {h}_{2} \vert}^{2} {P}_{R}} + {log}_{2} ( 1 + {\vert {h}_{2} \vert}^{2} {P}_{R} ) , \\ {f}_{3} ( {Δ}_{1} ) = \begin{matrix}- {Δ}_{1} \{ \begin{matrix}{log}_{2} ( 1 + {\vert {h}_{1} \vert}^{2} {P}_{R} ) + \\ {log}_{2} ( 1 + {\vert {h}_{2} \vert}^{2} {P}_{R} )\end{matrix} \} + \\ \{ \begin{matrix}{log}_{2} ( 1 + {\vert {h}_{1} \vert}^{2} {P}_{R} ) + \\ {log}_{2} ( 1 + {\vert {h}_{2} \vert}^{2} {P}_{R} )\end{matrix} \} .\end{matrix} \qquad [ Equation 9 ]$$

Here, f₀ represents the sum of the transmission rate of the signal from the source node S1 to the relay R and the transmission rate of the signal from the source node S2 to the relay R, f₁ represents the sum of the transmission rate of the signal from the source node S1 to the relay R and the transmission rate of the signal from the relay R to the source node S1, f₂ represents the sum of the transmission rate of the signal from the relay R to the source node S2 and the transmission rate of the signal from the source node S2 to the relay R, and f₃ represents the sum of the transmission rate of the signal from the relay R to the source node S2 and the transmission rate of the signal from the relay R to the source node S1.

Each function satisfies the following conditions.

f₀(0)<f₁(0)<f₃(0),

f₀(0)<f₂(0)<f₃(0),

f₃(1)<f₁(1)<f₀(1),

f₃(1)<f₂(1)<f₀(1).

The function f varies within the range of 0≦Δ₁≦1, and the remainder f₀ and f₃ except for f₁ and f₂ meet each other at one point. That is, because f is a function representing the sum of transmission rates for nodes, the time at which the sums of transmission rates for nodes are the same occurs exactly once even with any transmission time.

The point at which f₁ and f₃ intersect and the point at which f₂ and f₀ intersect are the same. That is, the point at which f₁ and f₃ intersect and the point at which f₂ and f₀ intersect meet at the same Δ₁. If the intersecting time at which the intersecting point between f₁ and f₃ and the intersecting point between f₂ and f₀ meet at the same Δ₁ is referred to as t₁, the intersecting time t₁ may be defined as follows.

$${t}_{1} = \frac{{log}_{2} ( 1 + {\vert {h}_{2} \vert}^{2} {P}_{R} )}{{log}_{2} ( 1 + {\vert {h}_{1} \vert}^{2} {P}_{1} ) + {log}_{2} ( 1 + {\vert {h}_{2} \vert}^{2} {P}_{R} )} \qquad [ Equation 11 ]$$

In addition, the point at which f₁ and f₀ intersect and the point at which f₂ and f₃ intersect are the same. That is, the point at which f₁ and f₀ intersect and the point at which f₂ and f₃ intersect meet at the same Δ₁.

If the intersecting time at which the intersecting point between f₁ and f₀ and the intersecting point between f₂ and f₃ meet at the same Δ₁ is referred to as t₂, the intersecting time t₂ may be defined as follows.

$${t}_{2} = \frac{{log}_{2} ( 1 + {\vert {h}_{1} \vert}^{2} {P}_{R} )}{\begin{matrix}{log}_{2} ( 1 + {\vert {h}_{2} \vert}^{2} {P}_{2} ) + \\ {log}_{2} ( 1 + {\vert {h}_{1} \vert}^{2} {P}_{R} )\end{matrix}} \qquad [ Equation 12 ]$$

If t₁ and t₂ are the same, they are the same as the time at which f₃ and f₀ intersect. If the time at which f₃ and f₀ intersect is referred to as t₃, the intersecting time t₃ may be defined as follows.

$${t}_{3} = \frac{{log}_{2} ( 1 + {\vert {h}_{1} \vert}^{2} {P}_{R} ) + {log}_{2} ( 1 + {\vert {h}_{2} \vert}^{2} {P}_{R} )}{\begin{matrix}{log}_{2} ( 1 + {\vert {h}_{1} \vert}^{2} {P}_{1} ) + {log}_{2} ( 1 + {\vert {h}_{2} \vert}^{2} {P}_{2} ) + \\ {log}_{2} ( 1 + {\vert {h}_{1} \vert}^{2} {P}_{R} ) + {log}_{2} ( 1 + {\vert {h}_{2} \vert}^{2} {P}_{R} )\end{matrix}} \qquad [ Equation 13 ]$$

Here, the number of combinations that are possible to consider for (|h₁|², |h₂|², P₁, P₂, P_{R}) is very large, and the combinations may be divided into three disjoint sets as follows.

Ω₁={(|h₁|²,|h₂|²,P₁,P₂,P_{R})|t₁<t₂},

Ω₂={(|h₁|²,|h₂|²,P₁,P₂,P_{R})|t₁>t₂},

Ω₃={(|h₁|²,|h₂|²,P₁,P₂,P_{R})|t₁=t₂}. [Equation 14]

The disjoint sets may be proven based on the following Equation 15.

f₃(t₃)=f₀(t₃)<f₁(t₃) for t₁<t₂,

f₃(t₃)=f₀(t₃)=f₁(t₃) for t₁=t₂,

f₃(t₃)=f₀(t₃)>f₁(t₃) for t₁>t₂,

f₃(t₃)=f₀(t₃)<f₂(t₃) for t₂<t₁,

f₃(t₃)=f₀(t₃)=f₂(t₃) for t₂=t₁,

f₃(t₃)=f₀(t₃)>f₂(t₃) for t₂>t₁. [Equation 15]

Accordingly, the optimal solution for each disjoint set is as follows.

[Equation 16]

| Cases | Subcases | Δ₁* |
|---|---|---|
| | P₂ < P_{R} | t₁ |
| t₁ < t₂ | P₂ = P_{R} | [t₁, t₂] |
| | P₂ > P_{R} | t₂ |
| | P₁ < P_{R} | t₂ |
| t₁ > t₂ | P₁ = P_{R} | [t₂, t₁] |
| | P₁ > P_{R} | t₁ |
| t₁ = t₂ | | t₁ = t₂ = t₃ |

Therefore, if each intersecting time t₁, t₂, and t₃ and the transmission powers of a source node and a relay are calculated, the optimal time value of transmission time may be simply and rapidly obtained.

In this exemplary embodiment of the present invention, conditions in which equal time allocation and optimal time allocation are the same are as follows.

$$\begin{matrix}1 & {t}_{1} = \frac{1}{2} < {t}_{2} and {P}_{2} \leq {P}_{R} \\ 2 & {t}_{1} = \frac{1}{2} > {t}_{2} and {P}_{1} \geq {P}_{R} \\ 3 & {t}_{1} < {t}_{2} = \frac{1}{2} and {P}_{2} \geq {P}_{R} \\ 4 & {t}_{1} > {t}_{2} = \frac{1}{2} and {P}_{1} \leq {P}_{R} \\ 5 & {t}_{1} < \frac{1}{2} < {t}_{2} and {P}_{2} = {P}_{R} \\ 6 & {t}_{2} < \frac{1}{2} < {t}_{1} and {P}_{1} = {P}_{R} \\ 7 & {t}_{1} = {t}_{2} = \frac{1}{2}\end{matrix} \qquad [ Equation 17 ]$$

The equal time allocation represents that the first transmission time deltal and the second transmission time delta2 are allocated half and half. The optimal time allocation represents that the first transmission time delta1 and the second transmission time delta2 are differently allocated, so that the transmission rate may be maximized, such that it is possible to find an optimal transmission time.

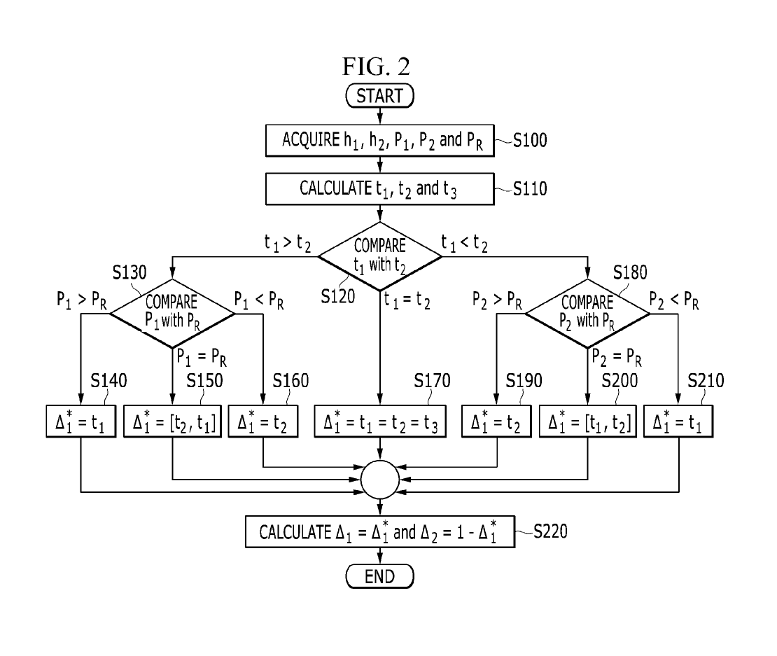

FIG. 2 shows a flowchart of a method for allocating transmission time according to an exemplary embodiment of the present invention.

In a bi-directional relay communication environment as in FIG. 1, basic parameters are acquired, where the basic parameters include a channel coefficient h₁ for a channel from the source node S1 to the relay R, a channel coefficient h₂ for a channel from the source node S2 to the relay R, the first transmission power P of the signal transmitted from the source node S1, the second transmission power P₂ of the signal transmitted from the source node S2, and the third transmission power P_{R} of the signal transmitted from the relay R (S100).

Based on the basic parameters, the intersecting times at which the sums of transmission rates for nodes become equal are calculated by using Equation 11 and Equation 12. That is, the first intersecting time t₁ and the second intersecting time t₂ are calculated (S110), or the third intersecting time t₃ may optionally be calculated based on Equation 13.

After this, the calculated intersecting times are compared with each other (S120). Specifically, based on the disjoint set according to Equation 14, the first intersecting time t₁ and the second intersecting time t₂ are compared with each other.

When the first intersecting time t₁ is greater than the second intersecting time t₂, the first transmission power P₁ is compared with the third transmission power P_{R} (S130). When the first transmission power P₁ is greater than the third transmission power P_{R}, the first intersecting time t₁ is determined as a transmission time Δ*₁ (S140). When the first transmission power P₁ is the same as the third transmission power P_{R}, a time [t₂, t₁] is determined as a transmission time Δ*₁ (S150). That is, a time between the second intersecting time t₂ and the first intersecting time t₁ is determined as a transmission time Δ*₁.

Also, when the third transmission power P_{R} is greater than the first transmission power P₁, the second intersecting time t₂ is determined as a transmission time Δ*₁ (S160).

Meanwhile, when the first intersecting time t₁ is the same as the second intersecting time t₂ the first intersecting time t₁ or the second intersecting time t₂ is determined as a transmission time Δ*₁ (S170). At this time, a condition of Δ*₁=t₁=t₂=t₃ is satisfied.

Meanwhile, when the second intersecting time t₂ is greater than the first intersecting time t₁, the second transmission power P₂ is compared with the third transmission power P_{R} (S180). When the second transmission power P₂ is greater than the third transmission power P_{R}, the second intersecting time t₂ is determined as a transmission time Δ*₁ (S190). When the second transmission power P₂ is the same as the third transmission power P_{R}, a time [t₁, t₂] is determined as a transmission time Δ*₁ (S200). That is, a time between the first intersecting time t₁ and the second intersecting time t₂ is determined as a transmission time Δ*₁. Also, when the third transmission power P_{R} is greater than the second transmission power P₂, the first intersecting time t₁ is determined as a transmission time Δ*₁ (S210).

As above, after the transmission time Δ*₁ is calculated, the first final transmission time Δ₁ and the second final transmission time Δ₂ are calculated. Here, based on a condition of Δ₁=Δ*₁ and Δ₂=1−Δ₁, that is, a condition of Δ₂=1−Δ*₁, the first final transmission time Δ₁ and the second final transmission time Δ₂ are calculated (S220).

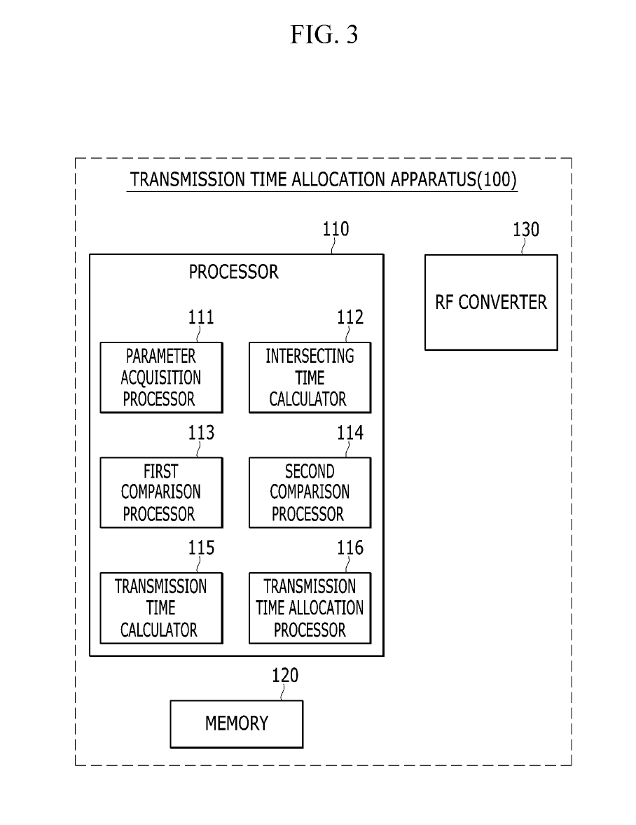

FIG. 3 shows a diagram illustrating a structure of an apparatus for allocating transmission time according to an exemplary embodiment of the present invention.

As shown in FIG. 3, a transmission time allocation apparatus 100 according to an exemplary embodiment of the present invention includes a processor 110, a memory 120, and a radio frequency (RF) converter 130. The processor 110 may be constructed to implement the methods described referring to FIG. 1 and FIG. 2.

For related descriptions of the processor 110 provided in this embodiment of the present invention that are not given in detail, refer to related descriptions of the above method and the accompanying drawings thereof. Details are not described herein again.

The processor 110 includes a parameter acquisition processor 111, an intersecting time calculator 112, a first comparison processor 113, a second comparison processor 114, a transmission time calculator 115, and a transmission time allocation processor 116.

The parameter acquiring processor 111 acquires parameters (the channel coefficients h₁ and h₂, the first transmission power P₁, the second transmission power P₂, the third transmission power P_{R}, and others) to be required for the transmission time calculation.

The intersecting time calculator 112 calculates the intersecting times at which the sums of transmission rates for nodes become equal, that is, the first intersecting time t₁ and the second intersecting time t₂, based on the parameters acquired by the parameter acquisition processor 111. At this time, Equation 11 and Equation 12 may be used. Further, the third intersecting time t₃ may also be calculated based on Equation 13.

The first comparison processor 113 compares the first intersecting time t₁ and the second intersecting time t₂.

The second comparison processor 114 compares the first transmission power P₁ and the third transmission power P_{R}, or compares the second transmission power P₂ and the third transmission power P_{R}, based on the results of the comparison by the first comparison processor 113.

The transmission time calculator 115 calculates a transmission time Δ*₁ based on the results of the comparison of the first transmission power P₁ and the third transmission power P_{R} or the results of the comparison of the second transmission power P₂ and the third transmission power P_{R}.

The transmission time allocation processor 116 allocates final transmission times based on the transmission time Δ*₁ calculated by the transmission time calculator 115. Specifically, the first final transmission time Δ₁ corresponding to the first time duration (time duration 1) and the second final transmission time Δ₂ corresponding to the second time duration (time duration 2) are allocated.

The memory 120 is connected to the processor 110 and stores various information associated with an operation of the processor 110. The memory 120 may be located at the inside or the outside of the processor 110, or may be connected to the processor 110 through connecting means such as a bus. The memory 120 may be a volatile or nonvolatile memory, and for example, a read-only memory (ROM) or a random access memory (RAM) may be included in the memory 120.

The RF converter 130 is connected to the processor 110 and transmits or receives a wireless signal.

According to an exemplary embodiment of the present invention, a theoretical optimal solution on transmission time allocation to achieve maximum transmission capacity has been proposed in a bi-directional relay system using physical layer network coding (PNC), and thereby it is possible to allocate optimal transmission time. Therefore, the transmission capacity may be maximally increased and the transmission efficiency also may be improved.

The foregoing exemplary embodiments of the present invention are not implemented only by an apparatus and a method, and therefore may be realized by programs realizing functions corresponding to the configuration of the exemplary embodiment of the present invention or recording media on which the programs are recorded

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for allocating a transmission time in a bi-directional relay system in which bi-directional communication is performed between a first node and a second node through a relay, comprising:
acquiring basic parameters for transmission time allocation, where the basic parameters include a first transmission power of a signal transmitted from the first node and a second transmission power of a signal transmitted from the second node;
calculating a plurality of intersecting times at which sums of transmission rates for nodes become equal by using the basic parameters; and
allocating a transmission time based on the plurality of the intersecting times, the first transmission power, and the second transmission power.

2. The method of claim 1, wherein the allocating of a transmission time comprises
determining a transmission time and then allocating a first final transmission time and a second final transmission time based on the determined transmission time,
wherein the first final transmission corresponds to a first time duration in which a signal from the first node is transmitted to the relay and a signal from the second node to the relay and the second final transmission time corresponds to a second time duration in which the relay processes received signals and transmits them to the first node and the second node.

3. The method of claim 2, wherein the plurality of intersecting times include a first intersecting time, a second intersecting time, and a third intersecting time based on a time at which a sum of transmission rates between the first node and the relay and a sum of transmission rates between the second node and the relay become equal.

4. The method of claim 3, wherein the allocating of transmission times comprises:
comparing the first intersecting time with the second intersecting time;
comparing the first transmission power with the third transmission power or the second transmission power with the third transmission power based on the results of the comparison of intersecting times; and
allocating transmission time by using the results of the comparison of intersecting times or the results of the comparison of transmission powers.

5. The method of claim 4, wherein the comparing the first transmission power comprises
comparing the first transmission power and the third transmission power when the first intersecting time is greater than the second intersecting time.

6. The method of claim 5, wherein the allocating of a transmission time comprises
determining the first intersecting time as a transmission time when the first transmission power is greater than the third transmission power.

7. The method of claim 5, wherein the allocating of a transmission time comprises
determining a time between the second intersecting time and the first intersecting time as a transmission time when the first transmission power is the same as the third transmission power.

8. The method of claim 5, wherein the allocating of a transmission time comprises
determining the second intersecting time as a transmission time when the third transmission power is greater than the first transmission power.

9. The method of claim 4, wherein the allocating of a transmission time comprises
determining the first intersecting time or the second intersecting time as a transmission time when the first intersecting time is the same as the second intersecting time.

10. The method of claim 4, wherein the comparing the first transmission power comprises
comparing the second transmission power with the third transmission power when the first intersecting time is greater than the second intersecting time.

11. The method of claim 10, wherein the allocating of a transmission time comprises
allocating the second intersecting time as a transmission time when the second transmission power is greater than the third transmission power.

12. The method of claim 10, wherein the allocating of a transmission time comprises
allocating a time between the first intersecting time and the second intersecting time as a transmission time when the second transmission power is the same as the third transmission power.

13. The method of claim 10, wherein the allocating of a transmission time comprises
allocating the first intersecting time as a transmission time when the third transmission power is greater than the second transmission power.

14. The method of claim 2, wherein the determining of a transmission time
allocates the determined transmission time as the first final transmission time, and allocates the second final transmission time based on the first final transmission time, where a condition of the second final transmission time=1—the first final transmission time is satisfied.

15. The method of claim 3, wherein
the basic parameters include a first channel coefficient for a channel between the first source node and the relay and a second channel coefficient for a channel between the second source node and the relay, and
the sum of transmission rates includes a first sum of transmission rates, a second sum of transmission rates, a third sum of transmission rates, and a fourth sum of transmission rates, wherein
the first intersecting time represents a time when a point at which the second sum of transmission rates and the fourth sum of transmission rates intersect and a point at which the third sum of transmission rates and the first sum of transmission rates intersect are the same, and
the second intersecting time represents a time when a point at which the second sum of transmission rates and the first sum of transmission rates intersect and a point at which the third sum of transmission rates and the fourth sum of transmission rates intersect are the same, wherein
the first sum of transmission rates represents a sum of a transmission rate from the first node to the relay and a transmission rate from the second node to the relay,
the second sum of transmission rates represents a sum of a transmission rate from the first node to the relay and a transmission rate from the relay to the first node,
the third sum of transmission rates represents a sum of a transmission rate from the second node to the relay and a transmission rate from the relay to the second node, and
the fourth sum of transmission rates represents a sum of a transmission rate from the relay to the second node and a transmission rate from the relay to the first node.

16. An apparatus for allocating a transmission time in a bi-directional relay system in which bi-directional communication is performed between a first node and a second node through a relay, comprising:
a wireless frequency converter configured to transmit/receive a signal through an antenna; and
a processor connected to the wireless frequency converter and configured to process transmission time allocation,
wherein the processor comprises:
a parameter acquiring processor configured to acquire basic parameters for transmission time allocation, where the basic parameters include a first transmission power of a signal transmitted from the first node, a second transmission power of a signal transmitted from the second node, a first channel coefficient for a channel between the first source node and the relay, and a second channel coefficient for a channel between the second source node and the relay;
an intersecting time calculator configured to calculate a plurality of intersecting times at which sums of transmission rates for nodes become equal by using the basic parameter;
a first comparison processor configured to compare a first intersecting time with a second intersecting time;
a second comparison processor configured to compare the first transmission power and the third transmission power or to compare the second transmission power and the third transmission power based on the results of the comparison by the first comparison processor; and
a transmission time allocation processor configured to allocate a transmission time based on the results of the comparison by the first comparison processor or the results of the comparison by the second comparison processor.

17. The apparatus of claim 16, wherein
the transmission time allocation processor is configured to determine a transmission time and then allocate a first final transmission time and a second final transmission time based on the determined transmission time, wherein
the first final transmission corresponds to a first time duration in which a signal from the first node is transmitted to the relay and a signal from the second node is transmitted to the relay, the second final transmission time corresponds to a second time duration in which the relay processes received signals and transmits them to the first node and the second node, and a condition of the second final transmission time=1—the first final transmission time is satisfied.

18. The apparatus of claim 16, wherein
the first sum of transmission rates represents a sum of a transmission rate from the first node to the relay and a transmission rate from the second node to the relay,
the second sum of transmission rates represents a sum of a transmission rate from the first node to the relay and a transmission rate from the relay to the first node,
the third sum of transmission rates represents a sum of a transmission rate from the second node to the relay and a transmission rate from the relay to the second node, and
the fourth sum of transmission rates represents a sum of a transmission rate from the relay to the second node and a transmission rate from the relay to the first node.

19. The apparatus of claim 18, wherein
the transmission time allocation processor is configured to determine the first intersecting time as a transmission time when the first intersecting time is greater than the second intersecting time and the first transmission power is greater than the third transmission power,
the transmission time allocation processor is configured to determine a time between the second intersecting time and the first intersecting time as a transmission time when the first intersecting time is greater than the second intersecting time and the first transmission power is the same as the third transmission power, and
the transmission time allocation processor is configured to determine the second intersecting time as a transmission time when the first intersecting time is greater than the second intersecting time and the third transmission power is greater than the first transmission power.

20. The apparatus of claim 18, wherein
the transmission time allocation processor is configured to determine the first intersecting time or the second intersecting time as a transmission time when the first intersecting time is the same as the second intersecting time,
the transmission time allocation processor is configured to determine the second intersecting time as a transmission time when the first intersecting time is greater than the second intersecting time and the second transmission power is greater than the third transmission power,
the transmission time allocation processor is configured to determine a time between the second intersecting time and the first intersecting time as a transmission time when the first intersecting time is greater than the second intersecting time and the second transmission power is the same as the third transmission power, and
the transmission time allocation processor is configured to determine the first intersecting time as a transmission time when the first intersecting time is greater than the second intersecting time and the third transmission power is greater than the second transmission power.
